(19) United States
(12) Patent Application Publication
(10) Pub. No.: US 2026/0274329 A1
(43) Pub. Date: Sep. 17, 2026

(54) STEER-BY-WIRE HAND WHEEL ACTUATOR SINGLE TURN TRAVEL STOP

(71) Applicant: Steering Solutions IP Holding Corporation, Saginaw, MI (US)

(72) Inventor: Ryan D. Harris, Clio, MI (US)

(21) Appl. No.: 19/559,318

(22) Filed: Mar. 6, 2026

Related U.S. Application Data
(60) Provisional application No. 63/771,736, filed on Mar. 14, 2025.

(51) Int. Cl. B62D 5/00

(52) U.S. Cl. CPC B62D 5/001

(57) ABSTRACT

A vehicle steer-by-wire system includes a hand wheel actuator having a rotor and a spindle, the rotor coupled to a steering input device to rotate therewith, the spindle rotationally stationary relative to the rotor. The system also includes an airbag support at disposed at least partially within a hub of the steering input device and rotationally stationary relative to the steering input device. The system further includes a rotational travel stop assembly. The rotational travel stop assembly includes a first travel stop feature protruding from the airbag support toward the hand wheel actuator. The rotational travel stop assembly also includes a second travel stop feature protruding from the rotor toward the steering input device.

### CROSS-REFERENCE TO RELATED APPLICATION

This application claims the benefits of priority to U.S. Provisional Patent Application Ser. No. 63/771,736, filed Mar. 14, 2025, the disclosure of which is incorporated by reference herein in its entirety.

### FIELD OF THE INVENTION

The embodiments described herein relate to vehicle steering systems and, more particularly, to a steer-by-wire hand wheel actuator single turn travel stop.

### BACKGROUND

Vehicles include various types of steering system schemes to allow an operator to provide a steering input that results in manipulation of vehicle road wheels. Certain electrical connections are often made between the steering wheel and other components to provide various functions associated with the steering wheel. Current steer-by-wire hand wheel actuator designs use shafts to convey torque from an electric motor to the hand wheel. These designs rely on a clock-spring type mechanism in the wire harness to allow for multiple turns of the hand wheel while carrying electrical signals to air bag inflators and control buttons.

To prevent over-travel and damage of the clock-spring mechanism, a multi-turn mechanical travel stop is required. A clock spring type mechanism is expensive because of the number of components in the design. Additionally, inside the clock-spring is ribbon cable which must be terminated at header connectors on both ends to interface with the rest of the wire harness.

### SUMMARY

According to one aspect of the disclosure, a vehicle steer-by-wire system includes a hand wheel actuator having a rotor and a spindle, the rotor coupled to a steering input device to rotate therewith, the spindle rotationally stationary relative to the rotor. The system also includes an airbag support at disposed at least partially within a hub of the steering input device and rotationally stationary relative to the steering input device. The system further includes a rotational travel stop assembly. The rotational travel stop assembly includes a first travel stop feature protruding from the airbag support toward the hand wheel actuator. The rotational travel stop assembly also includes a second travel stop feature protruding from the rotor toward the steering input device.

According to another aspect of the disclosure, a vehicle steer-by-wire system includes a hand wheel actuator located between a steering input device and an end of a steering column jacket, the hand wheel actuator having an outrunner motor including a rotor and a spindle, the rotor coupled to the steering input device to rotate therewith, the spindle rotationally stationary relative to the rotor. The system also includes an airbag support disposed at least partially within a hub of the steering input device and rotationally stationary relative to the steering input device. The system further includes a rotational travel stop assembly. The rotational travel stop assembly includes a first travel stop feature protruding from the airbag support toward the hand wheel actuator. The rotational travel stop assembly also includes a second travel stop feature protruding from the rotor toward the steering input device, wherein contact between the second travel stop feature and a first side of the first travel stop feature after rotation in a first rotational direction limits rotational travel of the rotor and the steering input device in the first rotational direction, wherein contact between the second travel stop feature and a second side of the first travel stop feature after rotation in a second rotational direction limits rotational travel of the rotor and the steering input device in the second rotational direction, and wherein a total degree of rotational travel of the rotor and the steering input device permitted by the first travel stop feature and the second travel stop feature is less than 360 degrees.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 SCHEMATICALLY ILLUSTRATES A VEHICLE STEER-BY-WIRE SYSTEM.

FIG. 2 is a first perspective view of a hand wheel actuator single turn travel stop assembly for the steer-by-wire system in a partially disassembled condition.

FIG. 3 is a second perspective view of the hand wheel actuator single turn travel stop assembly for the steer-by-wire system in a partially disassembled condition.

FIG. 4 is a perspective view of a portion of the hand wheel actuator single turn travel stop assembly in an assembled condition.

FIG. 5 is a side, cross-sectional view of the hand wheel actuator single turn travel stop.

FIG. 6 is a perspective view of the hand wheel actuator and the travel stop assembly according to another aspect of the disclosure.

FIG. 7 is an end view of the hand wheel actuator single turn travel stop.

FIG. 8 is an angular diagram of the hand wheel actuator single turn travel stop.

FIG. 9 is a perspective view of a travel stop feature according to one aspect of the disclosure.

FIG. 9A is an end view of the travel stop feature according to another aspect of the disclosure illustrating radiused sides.

FIG. 10 is a perspective of a travel stop feature according to another aspect of the disclosure.

FIG. 11 is a perspective view of the travel stop assembly according to another aspect of the disclosure.

FIG. 12 is a perspective view of the travel stop assembly according to another aspect of the disclosure.

FIG. 13 is a perspective view of the travel stop assembly according to another aspect of the disclosure.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

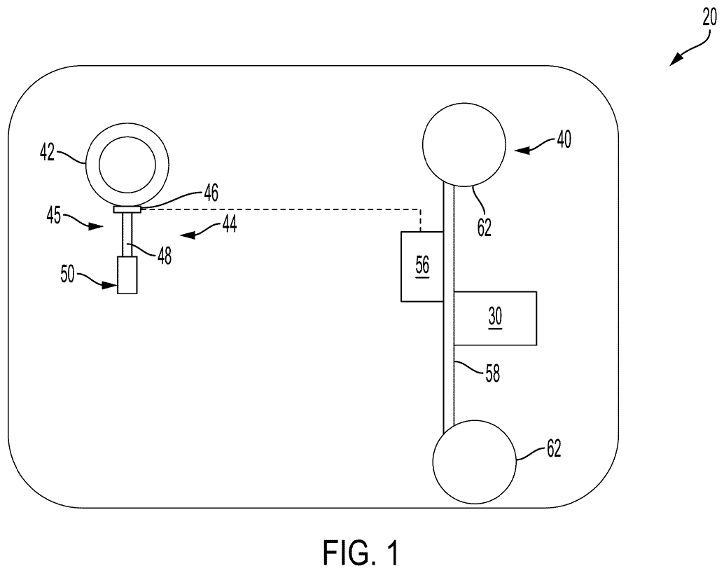

Referring initially to FIG. 1, a vehicle 20 is generally illustrated according to the principles of the present disclosure. The vehicle 20 may be any vehicle, such as a car, a truck, a sport utility vehicle, a mini-van, a crossover, any other passenger vehicle, any commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an internal combustion system, an electric system, or combinations thereof.

The vehicle 20 includes a steering system 40. The steering system 40 may be configured as a driver interface steering system, an autonomous driving system, or a system that allows for both driver interface and autonomous steering. The steering system includes a steering input device 42, such as a steering wheel, wherein a driver may manually provide a steering input by turning the steering wheel. A steering column assembly 44 includes a steering column 45 that extends along an axis. A hand wheel actuator (“HWA”) 46 (which may also be referred to as an “emulator”) is provided in the steer-by-wire system and is used to provide feedback and assistance to the steering input device 42 and to receive manual driver inputs for steering control.

The steering column 45 includes one or more portions, for example, an upper jacket 48 and a lower jacket 50. While two jackets are illustrated and described, it is to be appreciated that a single jacket or three or more jackets may be provided in some embodiments. Regardless of the number of jackets, the jackets may be axially and or height adjustable to be moveable over a range of positions to meet user preferences for positioning of the steering input device 42.

A road wheel actuator (“RWA”) 56 is in operative communication with the hand wheel actuator 46. The road wheel actuator 56 actuates lateral maneuvers of the vehicle in response to inputs received from the hand wheel actuator 46. Each of the hand wheel actuator 46 and the road wheel actuator 56 may include a respective processor and controller or a single processor may be in communication with a respective controller of each of the hand wheel actuator 46 and the road wheel actuator 56.

The road wheel actuator 56 is part of a system which includes an output that drives a rack, ball screw or any other cross-car oriented component that is operatively coupled to the road wheels 62.

Historically, a continuous mechanical connection spanning multiple components was utilized to connect the steering wheel 42 to the vehicle road wheels 62. However, steer-by-wire systems have eliminated the need for an uninterrupted mechanical connection between the steering wheel 42 and the vehicle road wheels 62. For example, a steering shaft which couples to the steering wheel and one or more additional shafts (e.g., intermediate shaft) is no longer needed in some systems. Advancements such as those outlined above present new opportunities and challenges in steer-by-wire systems. For example, certain components may be moved away from traditional locations to new locations within the system.

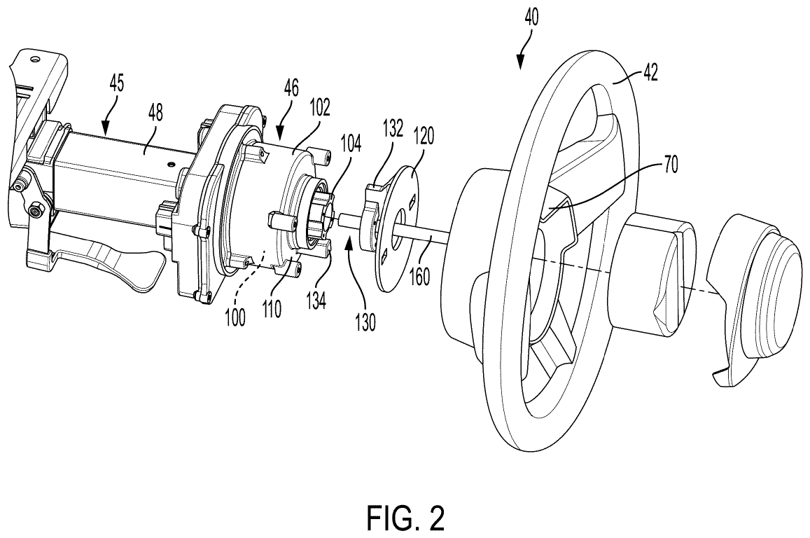

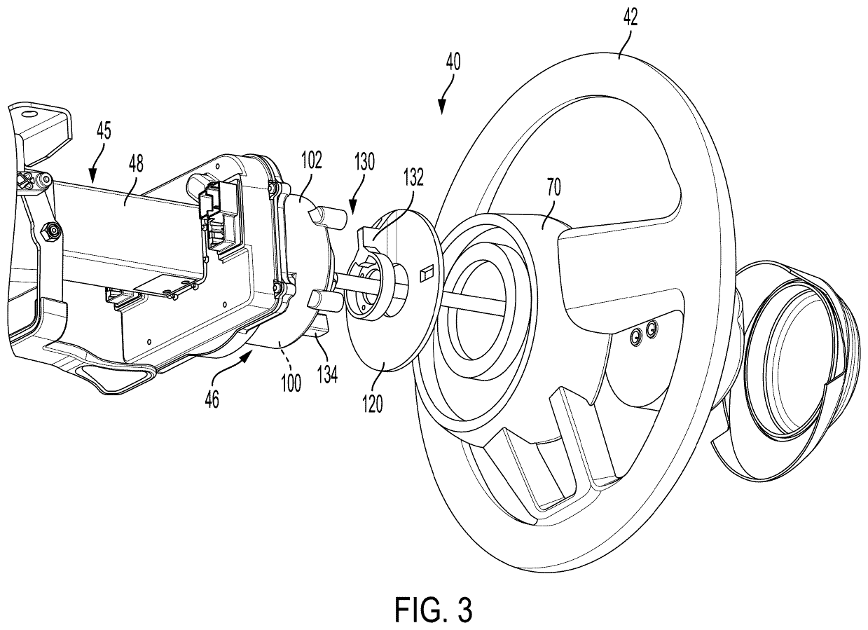

Referring now to FIGS. 2 and 3, a portion of the steering system 40 located adjacent to the steering wheel 42 is illustrated. A rearward portion of the steering wheel 42 is shown, with the hand wheel actuator 46 operatively coupled to the rear side (i.e., side of wheel away from operator) of the steering wheel 42. In the illustrated embodiment, the hand wheel actuator 46 is operatively coupled to a rearward side of a steering wheel hub 70. The hand wheel actuator 46 includes a motor 100 disposed within a motor housing 102. A spindle 104 is disposed within the motor 100. The steering wheel 42 is operatively coupled to the upper jacket 48 or to one or more intermediate components, such as an adaptor.

As disclosed herein, the motor of the hand wheel actuator is connected to the back of the steering input device 42. This may be referred to as a high or mid mount direct drive steer-by-wire hand wheel actuator. In this configuration, there is no steering shaft connecting the hand wheel to the motor. The system is configured to have a total rotation less of than 360 degrees, which allows for the embodiments of a robust mechanical travel stop to be implemented in the system. The travel stop is less complex and costly than other travel stop assemblies.

As described above, the hand wheel actuator 46 is located between the steering input device 42 and an end of the steering column 45, such as the upper jacket 48, such that the hand wheel actuator 46 is packaged forward (relative to vehicle front to back orientation) of the steering input device 42 and rearward of the jacket end. The motor 100 is an outrunner motor in which a rotor 110 is rotatable about a central axis and the spindle 104 is rotationally stationary relative to the rotor 110.

The rotor 110 is coupled to the steering input device 42 such that the rotor 110 rotates with the steering input device 42 during steering inputs. The spindle 104 defines an internal passage and presents an open end region adjacent the steering input device 42. In the illustrated embodiment, the spindle 104 is configured to be secured to non-rotating structure to remain rotationally stationary while the rotor 110 rotates about the spindle 104.

An airbag support 120 is disposed at least partially within the hub 70 region of the steering input device 42. The airbag support 120 is rotationally stationary relative to the steering input device 42 hub region in the sense that the airbag support 120 is fixed in a predetermined rotational relationship to the hub region and is not intended to rotate relative thereto during normal operation. The airbag support 120 provides a supporting structure for an airbag module and associated components, and the airbag support 120 is positioned rearward of the hand wheel actuator 46. In FIGS. 2 and 3, the airbag support 120 is shown in a partially disassembled condition relative to the spindle 104 so that alignment and travel stop features can be more readily seen.

A rotational travel stop assembly 130 is provided to limit angular travel of the rotor 110 and the coupled steering input device 42. The travel stop assembly 130 includes a first travel stop feature 132 protruding from the airbag support 120 toward the hand wheel actuator 46 and a second travel stop feature 134 protruding from the rotor 110 toward the steering input device 42. In the illustrated embodiment, the first travel stop feature 132 is integrally formed with the airbag support 120 as a projecting web or boss extending forwardly from a forward portion of the airbag support 120. The second travel stop feature 134 is integrally formed with the rotor 110 and extends rearwardly from the rotor 110 toward the airbag support 120.

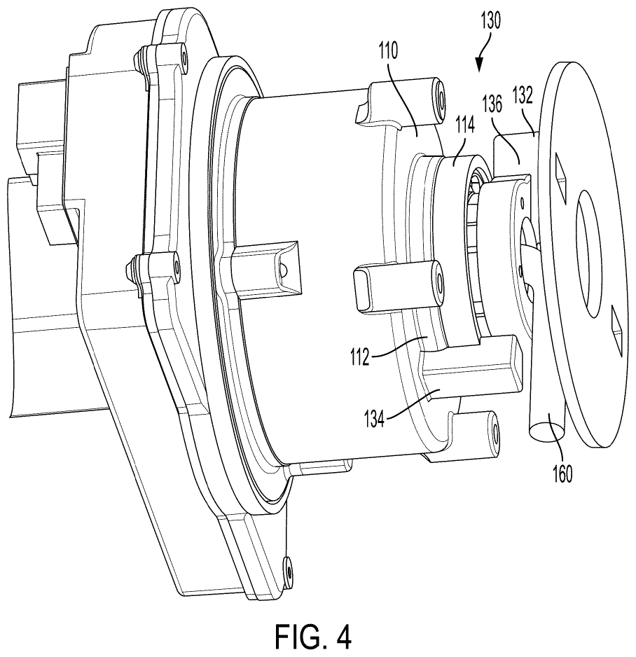

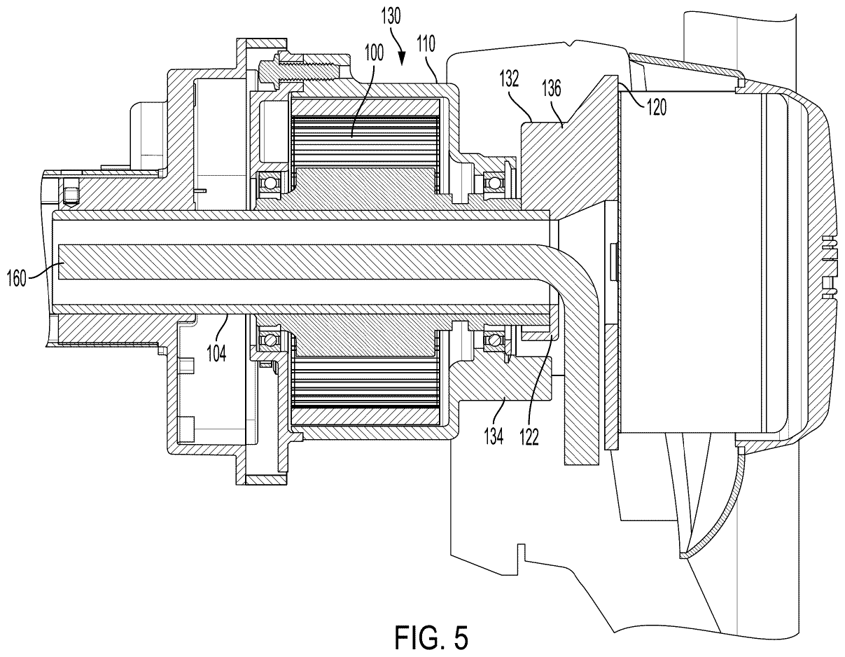

Referring to FIGS. 4 and 5, the travel stop assembly 130 is shown in an assembled condition. The first travel stop feature 132 and the second travel stop feature 134 are angularly positioned about the axis such that the second travel stop feature 134 rotates toward and into contact with the first travel stop feature 132 upon rotation of the rotor 110. The first travel stop feature 132 includes a first side 136 and a second side 138 that face generally circumferentially in opposite directions. The second travel stop feature 134 is configured to engage the first side 136 after rotation in a first rotational direction to limit rotational travel in the first rotational direction. The second travel stop feature 134 is further configured to engage the second side 138 after rotation in a second rotational direction to limit rotational travel in the second rotational direction. In this manner, the travel stop assembly 130 defines end-of-travel limits on both sides of a nominal center position.

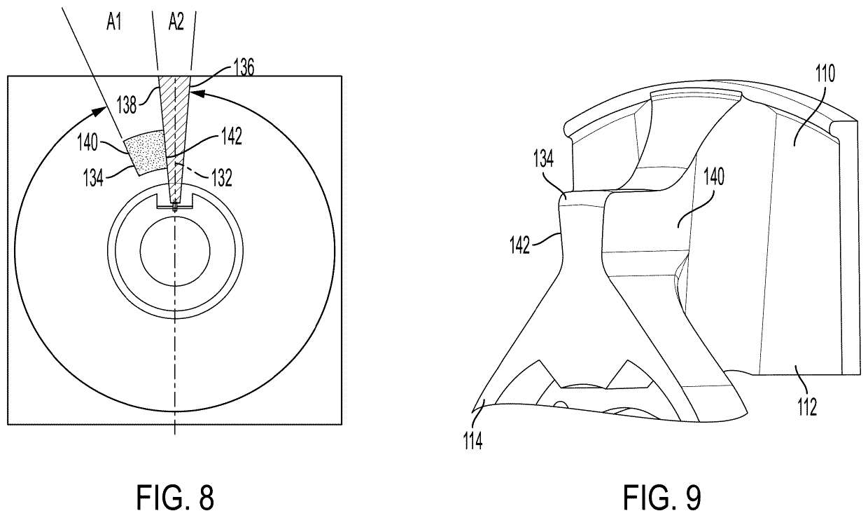

The total degree of rotational travel permitted by the travel stop assembly 130 is selected to be less than 360 degrees. As schematically represented in FIG. 8, the first travel stop feature 132 occupies a first angular width A2 about the axis and the second travel stop feature 134 occupies a second angular width A1 about the axis. With the first and second travel stop features 132, 134 circumferentially adjacent each other at end-of-travel, the allowable travel is determined by the circumferential gap between opposing engagement faces, such that the permitted rotation is less than a full turn. In some embodiments, the permitted total travel is approximately equal to 360 degrees minus the sum of the angular widths of the first and second travel stop features 132, 134, accounting for any designed clearances.

Referring to FIGS. 3-5, the rotor 110 includes a base portion 112 and a ring 114 extending from the base portion 112 toward the steering input device 42. The ring 114 is a generally annular structure centered on the axis and configured to rotate with the rotor 110. In the illustrated embodiment, the second travel stop feature 134 is integrally formed with the ring 114 and extends radially outwardly therefrom. The second travel stop feature 134 includes a first side 140 and a second side 142 that each intersect the ring 114, with the first and second sides 140, 142 being circumferentially facing surfaces that define opposite engagement directions for contacting the respective sides 136, 138 of the first travel stop feature 132. The second travel stop feature 134 further includes a radially outward extent selected to provide a desired shear area and stiffness when the travel stop assembly 130 is loaded at end-of-travel.

Referring to FIG. 5, the spindle 104 is disposed within the rotor 110 such that the rotor 110 rotates about the spindle 104. The airbag support 120 includes a hub portion 122 assembled to the spindle 104. The hub portion 122 is secured to the spindle 104 by a plurality of fasteners that clamp the airbag support 120 to the spindle 104, thereby maintaining the airbag support 120 in a fixed rotational relationship with the spindle 104. To further provide rotational alignment during assembly and to resist torque transfer between the airbag support 120 and the spindle 104, the spindle 104 includes a keyway slot 150 defined on a radially outer surface of the spindle 104, and the airbag support 120 includes an alignment key 152 protruding therefrom and received in the keyway slot 150. The alignment key 152 and keyway slot 150 cooperate to align the airbag support 120 relative to the spindle 104 in a desired rotational position so that the first travel stop feature 132 is located at a predetermined angular position relative to the spindle 104.

Referring to FIGS. 2, 3, and 5, the system further includes a wire conduit tube 160 disposed within the spindle 104 and extending out of an open end of the spindle 104. The wire conduit tube 160 is configured to route conductors associated with the steering input device 42, such as conductors for control buttons, through the interior of the spindle 104 while allowing the rotor 110 and steering input device 42 to rotate through the permitted travel range established by the travel stop assembly 130. The wire conduit tube 160 is positioned relative to the airbag support 120 and the travel stop assembly 130 such that, during rotation of the rotor 110, the rotor 110 and the second travel stop feature 134 do not interfere with the wire conduit tube 160 within the permitted travel range.

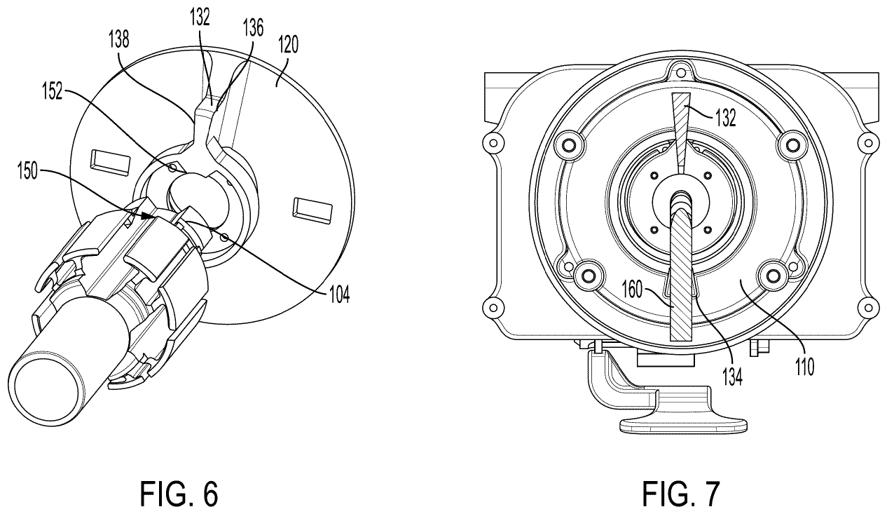

Referring to FIG. 6, another assembled view of the hand wheel actuator 46 and the travel stop assembly 130 is shown to illustrate that the travel stop features 132, 134 may be implemented with different external contours while maintaining the same functional relationship. In this aspect, the first travel stop feature 132 remains a projection from the airbag support 120 toward the hand wheel actuator 46 and the second travel stop feature 134 remains a projection from the rotor 110 toward the steering input device 42, with the travel stop features 132, 134 arranged to contact one another on opposite sides after rotation in respective opposite rotational directions to limit total travel to less than 360 degrees.

Referring to FIG. 7, an end view of the travel stop assembly 130 illustrates the relative circumferential placement of the first travel stop feature 132 fixed relative to the spindle 104 and the second travel stop feature 134 carried by the rotor 110. In the illustrated orientation, the airbag support 120 and its first travel stop feature 132 are shown at a fixed angular position, while the second travel stop feature 134 is positioned to rotate into engagement with the first travel stop feature 132 as the rotor 110 rotates toward an end-of-travel. FIG. 8 further illustrates angular relationships used to define the end-of-travel limits, including the angular widths of the first and second travel stop features 132, 134 and the resulting allowable travel range that is less than 360 degrees.

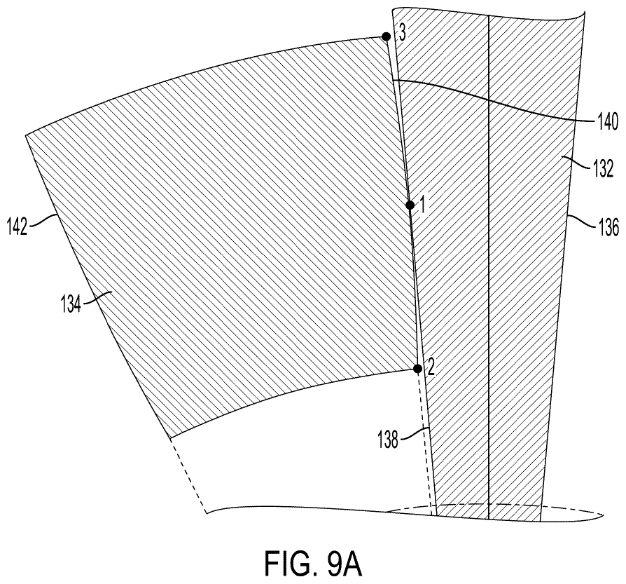

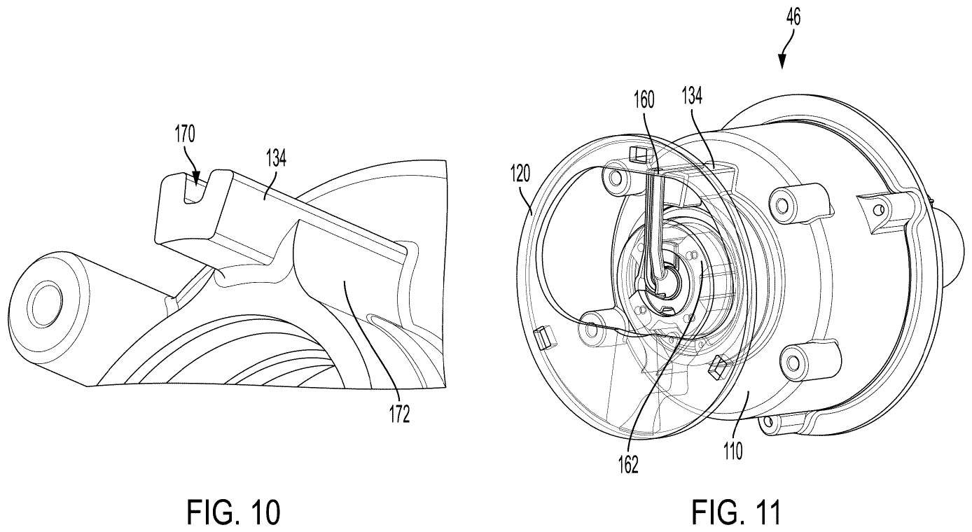

Referring to FIGS. 10 and 11, in some embodiments the second travel stop feature 134 includes a wire routing drive interface configured to cooperate with the wire conduit tube 160. In the illustrated embodiment, the second travel stop feature 134 defines a U-shaped channel 170 extending from a free end region of the second travel stop feature 134 toward the rotor 110. The U-shaped channel 170 is defined by opposed side walls and a base wall and is open in a radially outward direction relative to the axis, such that the U-shaped channel 170 forms a pocket sized to receive a portion of the wire conduit tube 160.

In other embodiments, the hand wheel actuator 46 includes an end plate coupled to the rotor 110 and configured to rotate with the rotor 110 about the spindle 104. The end plate may be implemented as a rotor end cover that closes an axial end of the rotor 110 and provides an axially facing surface region toward the steering input device 42. In this embodiment, the end plate defines the second travel stop feature 134, as shown in FIG. 11. More particularly, the second travel stop feature 134 is formed as a projection of the end plate that extends toward the steering input device 42 and is positioned to selectively contact the first travel stop feature 132 at opposite ends of the permitted travel range to limit rotational travel to less than 360 degrees. The end plate further defines a hole sized to receive a portion of the wire conduit tube 160 therethrough. The hole may be positioned radially inward of the second travel stop feature 134 and provides a pass-through opening for the wire conduit tube 160 while maintaining clearance between the wire conduit tube 160 and the end plate during rotation of the rotor 110 within the permitted travel range. In some embodiments, the hole is sized with a predetermined clearance relative to an outer diameter of the wire conduit tube 160 to accommodate manufacturing tolerances and relative movement during rotation, while maintaining the wire conduit tube 160 in a desired routing position through the hand wheel actuator 46.

As further shown in FIGS. 10 and 11, the wire conduit tube 160 is routed from the steering input device 42 toward an open end of the spindle 104 and includes an external tube portion 162 positioned adjacent to the travel stop assembly 130. A portion of the external tube portion 162 is disposed within the U-shaped channel 170 so that the second travel stop feature 134 at least partially captures the wire conduit tube 160. In this arrangement, rotation of the rotor 110 causes corresponding rotation of the second travel stop feature 134, and the wire conduit tube 160 is driven to rotate with the rotor 110 by engagement between the U-shaped channel 170 and the external tube portion 162.

FIGS. 10 and 11 further illustrate that the U-shaped channel 170 may include blended radii 172 along one or more transitions between the side walls and the base wall and/or along one or more edges adjacent the free end region. The blended radii 172 may be provided to reduce stress concentrations in the second travel stop feature 134 and to reduce contact loading against the wire conduit tube 160 during rotation. In addition, FIGS. 10 and 11 illustrate that one or more adjacent regions of the second travel stop feature 134 may include radiused or relieved surfaces selected to maintain clearance between the wire conduit tube 160 and the airbag support 120 at the ends of travel defined by engagement between the first travel stop feature 132 and the second travel stop feature 134.

Referring to FIGS. 9 and 10, the rotor 110 includes the ring 114 extending from the base portion 112 toward the steering input device 42, and the second travel stop feature 134 is carried by the rotor 110 and extends radially outwardly from the ring 114. The second travel stop feature 134 includes the first side 140 and the second side 142 that each intersect the ring 114 and provide circumferentially facing engagement surfaces for contact with corresponding sides of the first travel stop feature.

Referring now to FIGS. 8-9A, the first side 140 and the second side 142 of the second travel stop feature 134 have radiused surfaces from an end view in some embodiments. In particular, the sides 140, 142 have curvature extending through points 1, 2 and 3 on the embodiment shown in FIG. 9A. The radiused configuration provides a more predictable line of contact between the first and second travel stop features. If both first and second travel stop features 132, 134 were entirely planar in configuration, small manufacturing tolerances may lead the contact between the faces to occur at a sharp end with a line contact coming from either the innermost or outermost radial edge of the second travel stop feature 134. Additionally, the radius on the contact faces of the second travel stop feature 134 minimize contact stress when a large radius is used. For example, the radius of curvature of the sides 140, 142 may be between 160 mm to 240 mm in some embodiments, however, it us to be appreciated that other ranges may be appropriate for other applications of use.

In the embodiment shown in FIG. 10, the first side 140 and the second side 142 of the second travel stop feature 134 each include a radius of curvature that blends into the ring 114. The blended radius may be provided at the intersection of each side 140, 142 with the ring 114 to reduce stress concentrations in the second travel stop feature 134 during end-of-travel loading and to improve manufacturability of the rotor 110, including castability, while maintaining the functional engagement of the sides 140, 142 with the first travel stop feature.

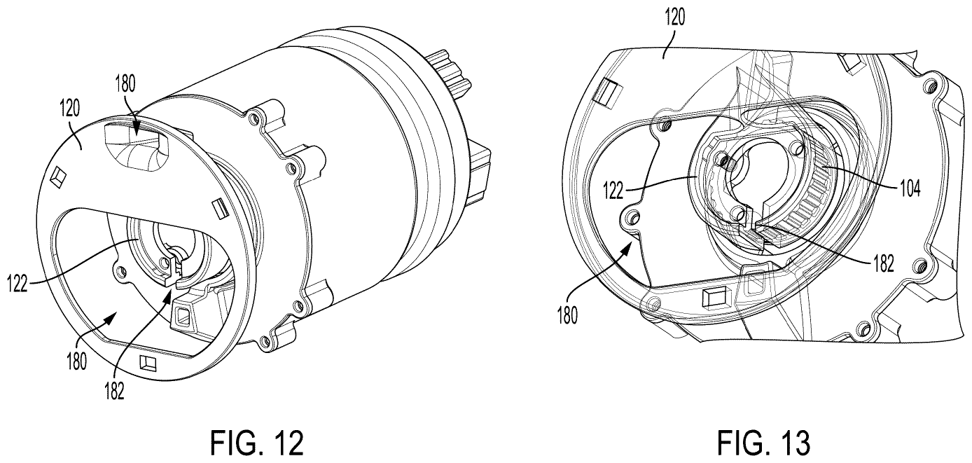

Referring to FIGS. 12 and 13, in some embodiments the airbag support 120 defines a plurality of hollow portions 180. The hollow portions 180 may be formed as cavities, pockets, or voided regions within one or more walls of the airbag support 120 and may be distributed circumferentially about the axis. The hollow portions 180 may be provided to improve manufacturability of the airbag support 120, including improving castability by promoting more uniform wall thickness and reducing localized shrink and mass, while maintaining structural strength sufficient to react end-of-travel loads transferred through the first travel stop feature 132 during engagement with the second travel stop feature 134.

As further shown in FIGS. 12 and 13, the airbag support 120 includes a hub portion 122 configured to be assembled to the spindle 104. In the illustrated embodiment, the hub portion 122 defines a circumferential gap 182 to provide a discontinuity in the hub portion 122. The circumferential gap 182 may be implemented as a split in the hub portion 122 that opens to an outer perimeter of the hub portion 122 and extends axially along at least a portion of the hub portion 122. The circumferential gap 182 facilitates assembly of the hub portion 122 to the spindle 104 by permitting the hub portion 122 to be installed in an assembly sequence in which components positioned through or adjacent the hub region are present prior to the airbag support 120 being secured to the spindle 104, while the hub portion 122 remains clampable to the spindle 104 to maintain the airbag support 120 rotationally stationary relative to the spindle 104 during operation.

In operation, when a steering input is applied, the steering input device 42 drives rotation of the rotor 110 about the rotationally stationary spindle 104. During normal operation within the travel range, the second travel stop feature 134 remains spaced from the first travel stop feature 132. Upon approaching an end-of-travel in a first rotational direction, the second travel stop feature 134 contacts the first side 136 of the first travel stop feature 132 and blocks further rotation in the first rotational direction. Upon approaching an end-of-travel in an opposite second rotational direction, the second travel stop feature 134 contacts the second side 138 of the first travel stop feature 132 and blocks further rotation in the second rotational direction. The first and second travel stop features 132, 134 thereby provide a robust, repeatable mechanical limit on rotational travel, with the permitted total travel being less than one full turn.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A vehicle steer-by-wire system comprising:
a hand wheel actuator having a rotor and a spindle, the rotor coupled to a steering input device to rotate therewith, the spindle rotationally stationary relative to the rotor;
an airbag support at disposed at least partially within a hub of the steering input device and rotationally stationary relative to the steering input device; and
a rotational travel stop assembly comprising:
a first travel stop feature protruding from the airbag support toward the hand wheel actuator; and
a second travel stop feature protruding from the rotor toward the steering input device.

2. The vehicle steer-by-wire system of claim 1, wherein the first travel stop feature is integrally formed with the airbag support.

3. The vehicle steer-by-wire system of claim 1, wherein the second travel stop feature is integrally formed with the rotor.

4. The vehicle steer-by-wire system of claim 1, wherein contact between the second travel stop and a first side of the first travel stop after rotation in a first rotational direction limits rotational travel of the rotor and the steering input device in the first rotational direction, wherein contact between the second travel stop and a second side of the first travel stop after rotation in a second rotational direction limits rotational travel of the rotor and the steering input device in the second rotational direction, wherein the total degree of rotational travel of the rotor and the steering input device permitted by the first travel stop feature and the second travel stop feature is less than 360 degrees.

5. The vehicle steer-by-wire system of claim 1, further comprising a wire conduit tube disposed within the spindle of the hand wheel actuator and extending out of an open end of the spindle.

6. The vehicle steer-by-wire system of claim 5, wherein the second travel stop feature defines a U-shaped channel extending from a free end of the second travel stop feature toward the rotor.

7. The vehicle steer-by-wire system of claim 6, wherein a portion of the wire conduit tube is disposed within the U-shaped channel of the second travel stop feature.

8. The vehicle steer-by-wire system of claim 1, wherein the spindle includes a keyway slot defined on a radially outer surface thereof, wherein the air bag support includes an alignment key protruding therefrom to fit within the keyway slot to align the airbag support relative to the spindle in a desired rotational position.

9. The vehicle steer-by-wire system of claim 1, wherein the rotor includes a ring extending from a base toward the steering input device, wherein the second travel stop feature is integrally formed with the ring and extends radially outwardly therefrom, wherein the second travel stop feature includes a first side and a second side which each intersect the ring.

10. The vehicle steer-by-wire system of claim 9, wherein the first side and the second side of the second travel stop feature have a radiused form.

11. The vehicle steer-by-wire system of claim 9, wherein the first side and the second side of the second travel stop feature each include a radius of curvature that blends into the ring.

12. The vehicle steer-by-wire system of claim 5, wherein the hand wheel actuator includes an end plate, the end plate defining the second travel stop feature, wherein the end plate defines a hole that receives a portion of the wire conduit tube therethrough.

13. The vehicle steer-by-wire system of claim 1, wherein the airbag support defines a plurality of hollow portions.

14. The vehicle steer-by-wire system of claim 1, wherein the airbag support includes a hub portion which is assembled to the spindle, wherein the hub portion defines a circumferential gap to provide a discontinuity in the hub portion.

15. A vehicle steer-by-wire system comprising:
a hand wheel actuator located between a steering input device and an end of a steering column jacket, the hand wheel actuator having an outrunner motor including a rotor and a spindle, the rotor coupled to the steering input device to rotate therewith, the spindle rotationally stationary relative to the rotor;
an airbag support disposed at least partially within a hub of the steering input device and rotationally stationary relative to the steering input device; and
a rotational travel stop assembly comprising:
a first travel stop feature protruding from the airbag support toward the hand wheel actuator; and
a second travel stop feature protruding from the rotor toward the steering input device, wherein contact between the second travel stop feature and a first side of the first travel stop feature after rotation in a first rotational direction limits rotational travel of the rotor and the steering input device in the first rotational direction, wherein contact between the second travel stop feature and a second side of the first travel stop feature after rotation in a second rotational direction limits rotational travel of the rotor and the steering input device in the second rotational direction, and wherein a total degree of rotational travel of the rotor and the steering input device permitted by the first travel stop feature and the second travel stop feature is less than 360 degrees.

16. The vehicle steer-by-wire system of claim 15, wherein the first travel stop feature is integrally formed with the airbag support.

17. The vehicle steer-by-wire system of claim 15, wherein the second travel stop feature is integrally formed with the rotor.

18. The vehicle steer-by-wire system of claim 15, wherein the rotor includes a ring extending from a base toward the steering input device, and wherein the second travel stop feature is integrally formed with the ring and extends radially outwardly therefrom.

19. The vehicle steer-by-wire system of claim 17, wherein the first side and the second side of the second travel stop feature have a radiused form.

20. The vehicle steer-by-wire system of claim 19, wherein the first side and the second side of the second travel stop feature have a radius of curvature between 160 mm and 240 mm.
